(19) United States
(12) Patent Application Publication
(10) Pub. No.: US 2007/0184977 A1
(43) Pub. Date: Aug. 9, 2007

(54) Microwavable construct with thermally responsive indicator

(76) Inventors: Robert William Spiller, Asheville, NC (US); Glenn B. Small, Colorado Springs, CO (US); Douglas Davidson, Castle Rock, CO (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/492,746

(22) Filed: Jul. 25, 2006

Related U.S. Application Data
(60) Provisional application No. 60/703,714, filed on Jul. 29, 2005.

(51) Int. Cl. B41M 5/20

(52) U.S. Cl. 503/200

(57) ABSTRACT

A construct for heating a food item in a microwave oven includes a thermochromic ink. The thermochromic ink may be used alone or with other inks to create an impression of active heating, provide status information or instructions to the user, provide instructions about the use of the construct, provide information about a theme presented with the construct provide educational information, provide entertainment to a user, or any combination thereof.

### CROSS-REFERENCE TO RELATED APPLICATION

This application claims the benefit of U.S. Provisional Application No. 60/703,714, filed Jul. 29, 2005, which is incorporated herein by reference in its entirety.

### BACKGROUND

Microwave ovens have become a principle form of heating food in a rapid and effective manner. Several factors complicate the design of a microwavable package for a food item. For example, various food items have different sizes, different microwave heating characteristics, and different needs for bulk heating, browning, and/or crisping. As a result, each package must be tailored to each type of food item. At the same time, manufacturers of food items often prefer to use the same type of container to hold numerous different food items. Furthermore, various microwave ovens provide varying cook times for a particular food item. As such, despite recommended cook times provided by the food manufacturer, the consumer often must halt the cooking cycle repeatedly to examine the food item to determine whether the item is heated sufficiently. Thus, there is a need for a package or system that provides the user with a visual indication that the food item is ready to be stirred, turned over, removed from the microwave oven, or otherwise processed or handled.

### SUMMARY

The present invention relates generally to a construct for heating a food item in a microwave oven.

According to one aspect of the invention, the construct may comprise a presentment, for example, a word, number, symbol, shape, pattern, image, indicium, or any combination thereof, formed at least partially from a thermochromic ink that undergoes a change in color as a function of temperature, where the presentment creates an impression of an active heating process. The presentment may comprise an electrical coil, a flame, a grill pattern, heat waves, smoke, a natural gas burner, or any combination thereof. In one example, the change in color comprises a transition from a colorless state to a colored state, and the presentment is visible in the colored state. If desired, the thermochromic ink may be positioned proximate a microwave energy interactive material. For example, the construct may comprise at least one panel having a first surface and a second surface, where a susceptor overlies at least a portion of the first surface and the thermochromic ink overlies at least a portion of the second surface.

According to another aspect of the invention, the construct may comprise an indicium formed at least partially from a thermochromic ink that undergoes a change in color at a transition temperature, where the change in color of the thermochromic ink indicates the status of the heating of the food item. The change in color of the thermochromic ink may comprise a transition from a colorless state to a colored state, from a colored state to a colorless state, or from a first color to a second color. In one example, the transition temperature of the thermochromic ink is selected to correspond to a temperature of the food item at a particular point in the heating process. Any indicium may be used, for example, a word, number, symbol, shape, pattern, or any combination thereof. The indicium may be disposed on an outer surface of the construct, where it is visible to the user.

According to another aspect of the invention, the construct may comprise a presentment formed from an ink applied to at least a portion of an outer surface of the construct, and a thermochromic ink overlying the presentment. The thermochromic ink transitions from a colored state to a colorless state at a color transition temperature that corresponds to the temperature of the food item at a particular point in the heating process, thereby revealing the presentment. The revealing of the presentment serves as an indicator that the food item has reached the particular point in the heating process. In one variation, the thermochromic ink substantially conceals the presentment.

The presentment may be a word, number, symbol, shape, pattern, or any combination thereof, and may comprise a non-thermochromic ink, a thermochromic ink, or any combination thereof. Where the presentment is formed from a thermochromic ink, the thermochromic ink of the presentment may transition from a colored state to a colorless state at a color transition temperature approximately equal to the color transition temperature of the overlying thermochromic ink. Alternatively, the thermochromic ink of the presentment may transition from a colored state to a colorless state at a color transition temperature different from the color transition temperature of the overlying thermochromic ink. Alternatively still, the thermochromic ink of the presentment may transition from a colorless state to a colored state at a color transition temperature approximately equal to the color transition temperature of the overlying thermochromic ink. In a further alternative, the thermochromic ink of the presentment may transition from a colorless state to a colored state at a color transition temperature different from the color transition temperature of the overlying thermochromic ink.

According to still another aspect of the invention, the construct comprises a thermochromic ink overlying at least a portion of an outer surface thereof, where the thermochromic ink changes from a first color to a second color in response to thermal energy, and the thermochromic ink is selected such that the change from the first color to the second color occurs at a predetermined point in the heating process of the food item. The change in color of the thermochromic ink may be used to create an impression of active heating, provide a status of the heating of the food item, provide instructions for processing or handling the food item, or any combination thereof. If desired, at least one of the first color and the second color may be colorless. Alternatively, both the first color and the second color may be colored (not colorless). If desired, the construct also may include a non-thermochromic ink overlying at least a portion of the outer surface.

In one example, the change in color of the thermochromic ink may be used to create an impression of active heating, and the impression of active heating comprises a presentment selected from the group consisting of an electrical coil, a flame, a grill pattern, heat waves, smoke, a natural gas burner, and any combination thereof. In another example, the change in color of the thermochromic ink may be used to provide instructions for processing or handling the food item, and the instructions advise the user to wait, stir the food item, invert the food item, remove the cover, remove the plastic film, remove the food item, add ingredients, or any combination thereof. The change in color of the thermochromic ink may be reversible or irreversible.

According to a further aspect of the invention, a construct for heating a food item in a microwave oven comprises a thermochromic ink that undergoes a change in color as a function of temperature to reveal a presentment, where the presentment provides instructions about the use of the construct, provides information about a theme presented with the construct, provides educational information, provides entertainment to a user, or any combination thereof. The change in color of the thermochromic ink may comprise a transition from a colorless state to a colored state. Alternatively, the change in color of the thermochromic ink may comprise a transition from a colored state to a colorless state. Alternatively still, the change in color of the thermochromic ink may comprise a transition from a first color to a second color. If desired, the thermochromic ink may substantially conceal the presentment. The presentment may comprise a non-thermochromic ink, a thermochromic ink, or any combination thereof.

Additional aspects, features, and advantages of the present invention will become apparent from the following description and accompanying figures.

### BRIEF DESCRIPTION OF THE DRAWINGS

The description refers to the accompanying drawings in which like reference characters refer to like parts throughout the several views, and in which:

FIG. 1A schematically depicts a plan view of an exemplary tray including a thermochromic ink according to various aspects of the present invention, before being heated to the color transition temperature;

FIG. 1B schematically depicts the tray of FIG. 1A after being heated to the color transition temperature;

FIG. 2A schematically depicts a plan view of another exemplary tray including a thermochromic ink according to various aspects of the present invention, before being heated to the color transition temperature;

FIG. 2B schematically depicts the tray of FIG. 2A after being heated to the color transition temperature;

FIG. 3A schematically depicts a perspective view of an exemplary sleeve including a thermochromic ink according to various aspects of the present invention, before being heated to the color transition temperature;

FIG. 3B schematically depicts the sleeve of FIG. 3A after being heated to the color transition temperature;

FIG. 4A schematically depicts an exemplary overwrap for a food item, the overwrap including a thermochromic ink according to various aspects of the present invention, before being heated to the color transition temperature;

FIG. 4B schematically depicts the overwrap of FIG. 4A after being heated to the color transition temperature;

FIG. 5A schematically depicts a plan view of a top panel or lid of a carton having a first thermochromic ink layer applied thereto, according to various aspects of the present invention, before being heated to the color transition temperature;

FIG. 5B schematically depicts the top panel of FIG. 5A after being heated to the color transition temperature for the first thermochromic ink layer, thereby revealing a second thermochromic ink layer;

FIG. 5C schematically depicts the top panel of FIG. 5B after being heated to the color transition temperature for the second thermochromic ink layer, thereby revealing a third ink layer;

FIG. 6A schematically depicts a perspective view of an exemplary carton including a thermochromic ink on an exterior surface thereof according to various aspects of the present invention, in a closed configuration before being heated to the color transition temperature;

FIG. 6B schematically depicts the carton of FIG. 6A in an open configuration, before being heated to the color transition temperature;

FIG. 6C schematically depicts the carton of FIG. 6A in a closed configuration, after being heated to the color transition temperature;

FIG. 7A depicts a schematic cross-sectional view of an exemplary microwave energy interactive insulating material that may be used to form a construct in accordance with various aspects of the present invention;

FIG. 7B depicts the exemplary microwave energy interactive insulating material of FIG. 7A, in the form of a cut sheet;

FIG. 7C depicts the exemplary microwave energy interactive insulating sheet of FIG. 7B, upon exposure to microwave energy;

FIG. 7D schematically depicts an exemplary variation of the exemplary microwave energy interactive insulating material of FIG. 7A;

FIG. 8 depicts a schematic cross-sectional view of another exemplary microwave energy interactive insulating material that may be used to form a construct in accordance with various aspects of the present invention;

FIG. 9 depicts a schematic cross-sectional view of yet another exemplary microwave energy interactive insulating material that may be used to form a construct in accordance with various aspects of the present invention;

FIG. 10A depicts a schematic cross-sectional view of still another exemplary microwave energy interactive insulating material that may be used to form a construct in accordance with various aspects of the present invention;

FIG. 10B depicts the exemplary microwave energy interactive insulating material of FIG. 10A, in the form of a cut sheet; and

FIG. 10C depicts the exemplary microwave energy interactive insulating sheet of FIG. 10B, upon exposure to microwave energy.

### DESCRIPTION

The present invention relates generally to a material, container, tray, pan, sleeve, package, or any combination thereof (sometimes collectively “construct”) for heating a food item in a microwave oven. The construct includes a thermochromic ink that undergoes a change in color as a function of temperature. As the food item is heated on or within the construct, the ink is heated directly by the impinging microwave energy. Additionally, heat may be transferred to the thermochromic ink from the heating food item, or from the ink to the food item. When the ink reaches its color transition temperature, it changes from a first color or state to a second color or state.

The change in color or state may be reversible or irreversible. If the change is reversible, the ink reverts to its original color or state when the ink cools below its color transition temperature. Conversely, if the change is irreversible, the ink does not revert to its original color or state, even when the ink cools below its color transition temperature. Thus, although reversible color and state transitions are described in detail herein, it will be understood that irreversible transitions also are contemplated hereby. Additionally, it will be understood that the terms “first” or “initial” color or state and the terms “second” or “final” state are not intended to be restrictive. On the contrary, where the color change of the inks is reversible, either color or state could be viewed as “first” or “second”, or “initial” or “final”, depending on the color of the ink when viewed. Thus, for example, when viewing an ink that transitions between red at a lower temperature and blue at a higher temperature, red can be viewed as the “first” color as the ink is increasing in temperature, and blue can be viewed as the “first” color as the ink is decreasing in temperature.

In one aspect, one or more thermochromic inks may be used alone or with one or more non-thermochromic inks (i.e., inks that do not undergo a significant change in color in response to temperature) to connote an active heating process, for example, browning, broiling, grilling, cooking over an open flame, cooking on a stovetop, or the like (generally referred to as an “active heating process”).

In another aspect, one or more thermochromic inks may be used alone or with one or more non-thermochromic inks to indicate that the food item is at a particular point in the heating process, to provide instructions to the user, or any combination thereof. For example, many food items require rotating, turning over, or stirring during the heating process. Other items require removal of a film overwrap or other cover after a particular amount of time. Thus, the thermochromic ink may be selected to have a transition temperature that corresponds to a point in the heating process at which the food product should be stirred, rotated, inverted, removed, or that the cover should be removed, or that the food item should be processed or handled in some other manner.

If desired, the thermochromic ink may be provided on one or more particular areas of the construct proximate the areas of the food item that tend to heat before other areas, for example, adjacent the outer edges of a tray or bowl. As the food item heats, the ink also will heat. When the ink reaches the color transition temperature and changes from a first color to a second color, the user may be instructed, for example, to halt the heating process, stir the food item, and proceed with cooking. Optionally, the ink and construct may be selected so that the food item serves as a heat sink to draw heat from the ink. In this manner, the food item and the ink may heat at a more uniform rate, thereby enhancing the accuracy of the indicator.

In still another aspect, the thermochromic ink may be used both to create a visual impression of active heating and to serve as an indicator that the food item has reached a particular point in the heating process.

In yet another aspect, the thermochromic ink may be used to provide other information to the user. For example, the user may be instructed to “DISCARD AFTER USE” or to “PLEASE RECYCLE”. As another example, the user may be provided with safety information, for example, “CAUTION, HOT”, “HANDLE WITH CARE”, or “PACKAGE NOT FOR REUSE”.

In a still further aspect, the thermochromic ink may be used in an educational manner or for entertainment. For example, the thermochromic ink may be used to reveal the answer to one or more trivia questions. As another example, the thermochromic ink may be used to provide educational information about a particular topic. For instance, the construct may be themed with a particular type of animal, mineral, hobby, fictional or non-fictional character or person, a movie, television show, or the like, a comic book character, or any other theme. The thermochromic ink may be used to play games within the theme, provide information regarding the theme, or ask questions and/or reveal answers regarding the theme. As still another example, the thermochromic ink may be used to visually entertain or interest the user while heating the food item therein. For instance, the thermochromic ink may be used to conceal or reveal a pattern of cartoon characters in a particular setting (e.g., Winnie the pooh, then Tigger, then Piglet), or to make a fictional or non-fictional character or person say something (e.g., “it's ready!”, “school is fun!”, “I love macaroni and cheese!”, etc.) or do something (e.g., running, jumping, eating, dancing, etc.). As a still further example, the thermochromic ink may be used in a whimsical manner to entertain the user, for example, by providing humorous phrases or information before, during, and/or after the heating process.

Any suitable thermochromic ink or combination of thermochromic inks may be used in accordance with the present invention. The thermochromic ink may undergo a change in color at a particular temperature, or may gradually change color as the temperature of the ink increases or decreases through a temperature range. For simplicity, either type of transition is referred to herein as a “change” or “transition” in color. Numerous thermochromic inks are commercially available, for example, from Chromatic Technologies, Inc.

The thermochromic ink may be selected to have any first color or state and any second color or state, as desired. As used herein, the term “color” shall include both visible and invisible colors, colored and colorless, such that that an ink that is in a colorless state shall be referred to as having a color. Any of such inks may be opaque, transparent, or translucent. Thus, for example, the first color may be white, red, orange, yellow, green, blue, pink, purple, tan, brown, black, any other color, or may be colorless, and the second color may be white, red, orange, yellow, green, blue, pink, purple, tan, brown, black, or any other color, or may be colorless. Upon heating above a predetermined color transition temperature, the ink undergoes a change in color. If the transition is reversible, the ink reverts to its original color upon cooling below the predetermined color transition temperature.

The ink selected, the manner in which it is applied to the construct, and the pattern in which it is applied depend on various factors including, but not limited to, the food item to be heated, the type of construct used, and the desired color transition temperature. Thus, for each of the constructs and examples provided herein, it will be understood that the various thermochromic and non-thermochromic inks may be applied in the form of any suitable presentment or indicium, for example, a word, a number, a shape, a symbol, a continuous or discontinuous design or pattern, or any combination thereof. The presentment or indicium may provide status information or instructions to the user, and/or that resembles or connotes an active, traditional heating process. Examples include, but are not limited to, a natural gas flame, a heating coil, a flaming grill, hot charcoal or coals, an oven filament, a halogen burner, an open fire, heat “waves” or lines emanating from walls of a conventional oven, an arrow indicating that the food item should be stirred or turned over, or a word or group of words, such as “heating”, “hot”, “stir”, “flip over”, “invert”, “add ingredients”, “remove wrap”, “heating complete”, “ready”, or “warm”.

The various constructs of the invention may be prepared using one or more of numerous techniques, including printing, spraying, lamination, roll coating, etching, thermal bonding, chemical bonding, adhesive bonding, mechanical bonding, extrusion, and any other process. It also will be understood that the terms “apply” or “applied” are used herein for simplicity only, and that any of numerous processes may be used to dispose the thermochromic ink on, or incorporate the thermochromic ink into, any of the constructs, layers, or components thereof.

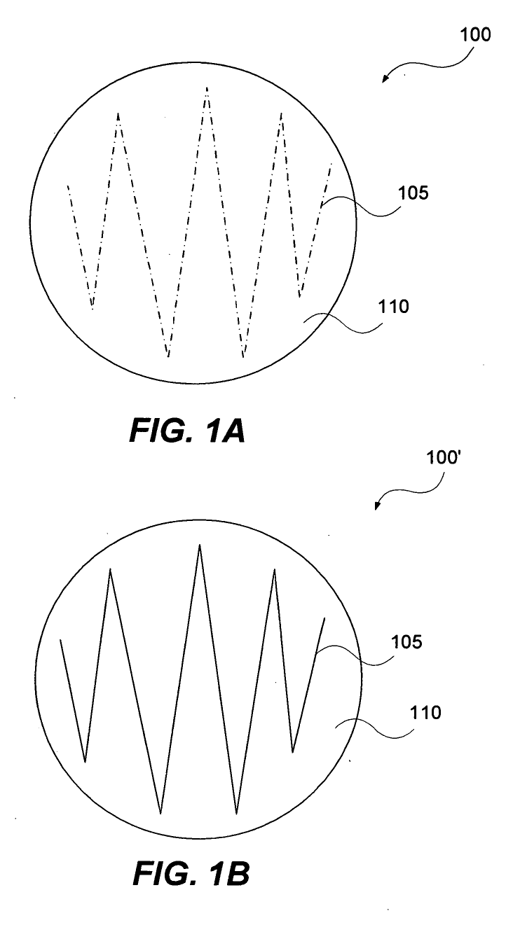

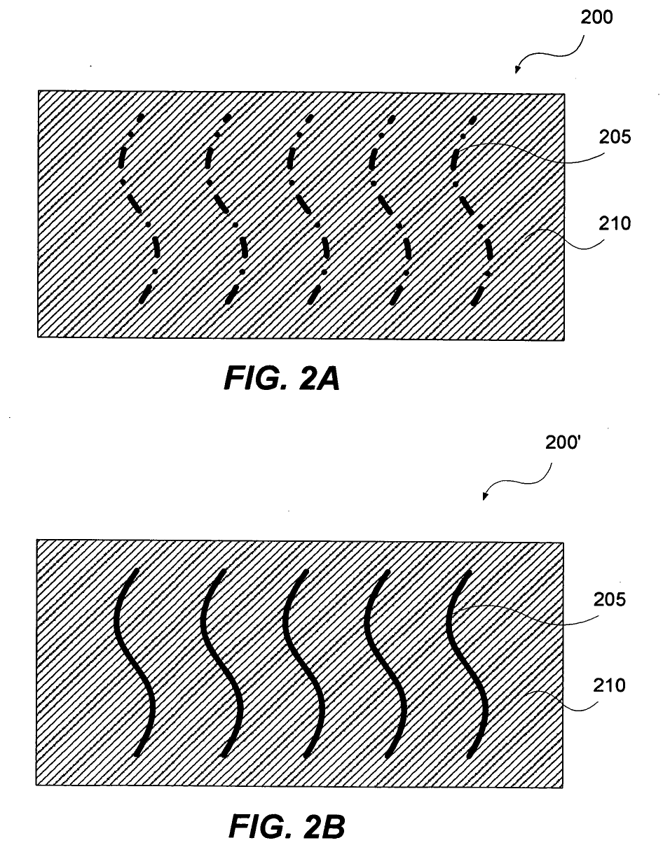

Some particular examples of constructs including thermochromic inks alone or in combination with non-thermochromic inks are provided in FIGS. 1A-6C. For purposes of simplicity, like numerals may be used to describe like features. It will be understood that where a plurality of similar features are depicted, not all of such features are necessarily labeled on each figure. While various examples are shown and described in detail herein, it also will be understood that any of the various features may be used with any construct described herein or contemplated hereby, in any combination.

FIG. 1A depicts a plan view of an exemplary microwavable tray 100, for example, a pizza tray. A thermochromic ink is applied to the tray 100 in a somewhat zigzag pattern 105 (indicated with a dashed line in FIG. 1A) that resembles or connotes an electrical heating element. When the thermochromic ink is below its color transition temperature, it appears either colorless or the color of the tray 100, for example, white, such that the zigzag pattern 105 is not visible. As shown in FIG. 1B, when the thermochromic ink is heated above its color transition temperature, the zigzag pattern of ink 105 becomes visible against the white background 110 of the tray 100′, thereby creating the impression of active heating with an electrical heating element. The zigzag pattern 105 may have any suitable color, for example, red, orange, yellow, blue, green, purple, brown, black, or any color or combination of colors, as desired.

FIG. 2A depicts a plan view of an exemplary microwavable tray 200, for example, a bacon tray. A thermochromic ink is applied to the tray 200 in a pattern of wavy lines 205 that resembles or connotes heat waves emanating from a food item (indicated with dashes in FIG. 2A). When the thermochromic ink is below its color transition temperature, it appears either colorless or the color of the tray 200, for example, silver, such that the wavy lines 205 are not visible. As shown in FIG. 2B, when the thermochromic ink is heated above its color transition temperature, the wavy lines of ink 205 become visible against the silver background 210 of the tray 200′, thereby creating the impression of active heating. The wavy lines 205 may have any suitable color, for example, red, orange, yellow, blue, green, purple, brown, black, or any color or combination of colors, as desired.

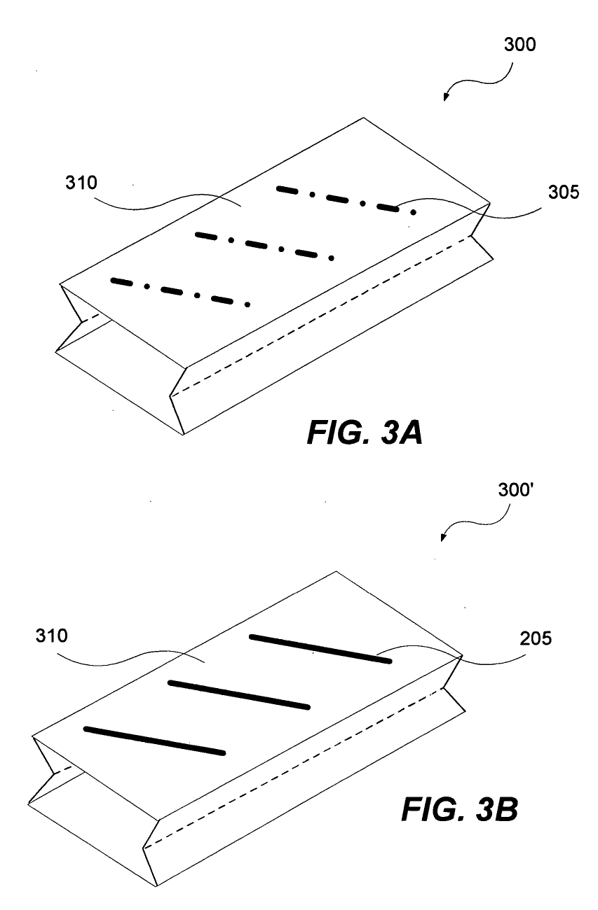

FIG. 3A depicts a plan view of an exemplary microwave heating sleeve 300, for example, for a meat filled pastry sandwich. A thermochromic ink is applied to the sleeve 300 in a somewhat striped pattern 305 to resemble char lines from a grill (indicated in dashed form in FIG. 3A). When the thermochromic ink is below its color transition temperature, it appears either colorless or the color of the sleeve 300, for example, white, such that the char line pattern 305 is not visible. As shown in FIG. 3B, when the thermochromic ink is heated above its color transition temperature, the pattern of ink 305 becomes visible against the white background 310 of the sleeve 300′. The char line pattern 305 may have any suitable color, for example, red, orange, yellow, blue, green, purple, brown, black, or any color or combination of colors, as desired.

Numerous other examples are contemplated hereby. Some additional examples of constructs that may be formed according to the present invention include, but are not limited to: a pizza tray including a thermochromic ink applied in the shape of a spiral heating coil, where the ink changes from a first color to red upon heating in a microwave oven; a tray for cooking a meat patty including a thermochromic ink applied to resemble a plurality of charcoal briquettes, where the ink changes from a first colorless, transparent “color” to orange upon heating in a microwave oven; a lasagna tray including a thermochromic ink applied to resemble one or more oven filaments, where the ink changes from a first color to red upon heating in a microwave oven; and a fruit pie construct including a thermochromic ink applied as a substantially continuous pattern, where the ink changes from a first color to red upon heating in a microwave oven.

If desired, a thermochromic ink may at least partially overlie and/or at least partially conceal another layer of ink. The underlying ink may be thermochromic or non-thermochromic, as needed or desired for a particular application. In such constructs, the thermochromic ink may be selected to have an initial, colored state and a second, colorless state. In this manner, when the thermochromic ink reaches the color transition temperature, it changes to a colorless, transparent ink, thereby revealing the underlying image formed from non-thermochromic ink, a thermochromic ink, or any combination thereof.

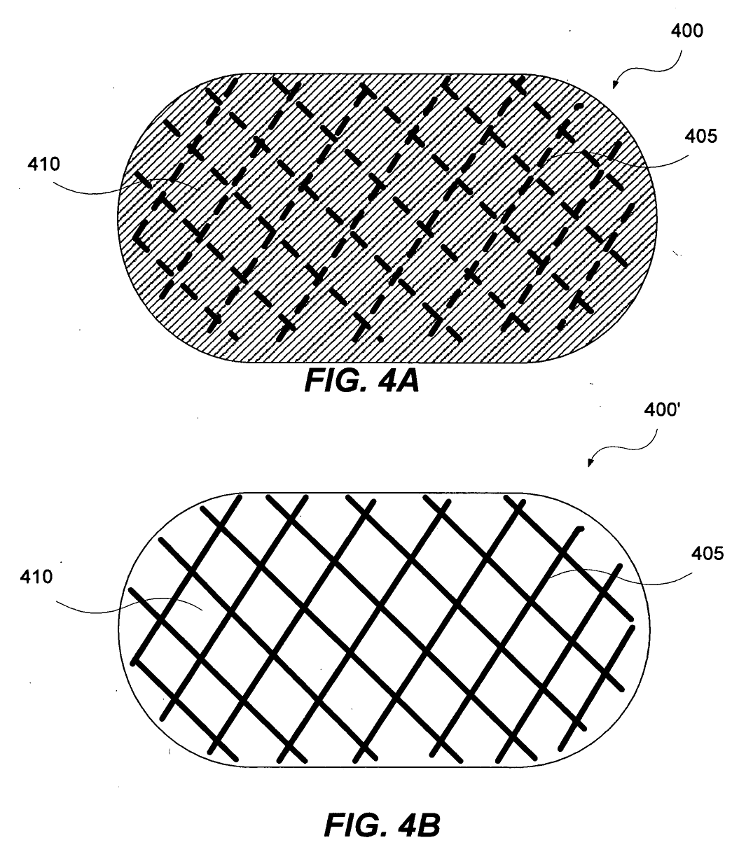

For example, FIG. 4A schematically depicts a flexible overwrap 400, for example, for a hot dog and bun (not shown). A non-thermochromic ink in a double char line pattern 405 (shown in dashed form in FIG. 4A) overlies at least a portion of the overwrap 400. A substantially continuous layer of thermochromic ink 410 overlies the non-thermochromic ink char pattern 405. When the thermochromic 410 ink is below its color transition temperature, it appears as a substantially continuous color, for example, light brown. As shown in FIG. 4B, when the thermochromic ink 410 reaches its color transition temperature, it becomes colorless, thereby revealing the double char pattern 405 on the overwrap 400′. The char line pattern 405 may have any suitable color, for example, red, orange, yellow, blue, green, purple, brown, black, or any color or combination of colors, as desired.

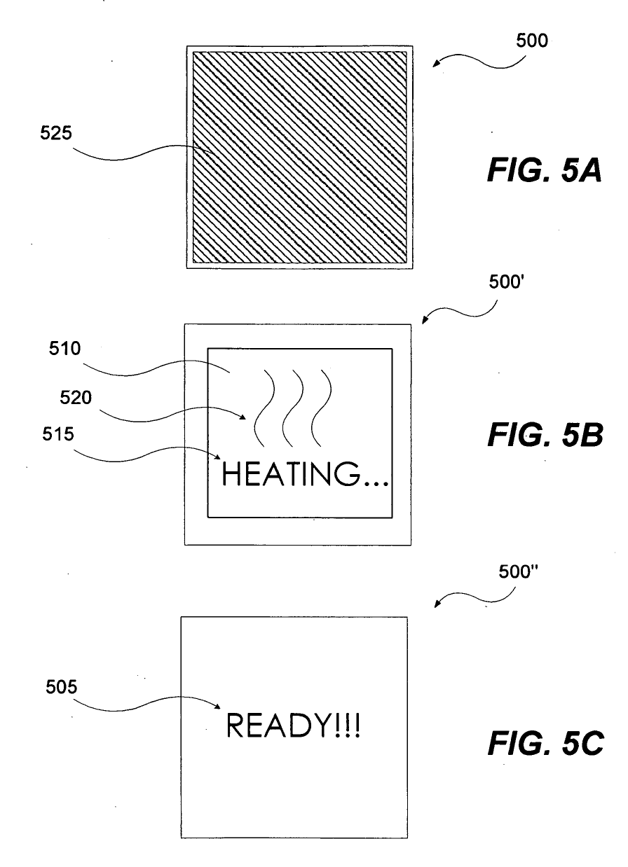

In another variation, the underlying indicator may be formed from a thermochromic ink having a color transition temperature that differs from that of the overlying thermochromic ink, so that it may undergo a subsequent color change to reveal yet another indicator. By way of example and not limitation, FIGS. 5A-5C schematically depict a construct 500 that includes multiple thermochromic inks that each undergo a change in color at different points during the heating process. As shown in FIG. 5C, the construct 500″ includes a verbal indicator 505 comprising the word “READY!!!” formed from a first “layer” of ink that may be thermochromic or non-thermochromic. Turning to FIG. 5B, a second “layer” of ink comprising one or more thermochromic inks at least partially overlies the first layer of ink. In this example, a thermochromic ink is selected to have a substantially solid background 510 with the word “HEATING . . . ” 515 and heat wave symbols 520 overlying the background 510. It will be understood that the background 510, word 515, and symbols 520 each may have a different color and/or transition temperature, as needed or desired to create the desired effect. The transition temperatures are selected to have an initial, colored state and a second, colorless state. When the temperature of the ink reaches the color transition temperature, the background ink, the word ink, and the symbol ink each become colorless and the underlying message “READY!!!” is revealed.

As illustrated in FIG. 5A, yet another “layer” of thermochromic ink substantially overlies and conceals the second layer of ink. In this example, the thermochromic ink is applied as a substantially continuous colored area 525. The thermochromic ink is selected to have an initial, colored state and a second, colorless state.

Now viewing FIGS. 5A-5C in sequence, the construct 500 generally has a colored appearance prior to heating and during the initial stages of heating (FIG. 5A). As the temperature of the food item and various inks increases, the third layer of ink 525 reaches its transition temperature and transitions from a colored state to a colorless state. In doing so, the underlying message “HEATING . . . ” 515, the accompanying symbols 520, and the background 510 are revealed (FIG. 5B) on the construct 500′. Likewise, when the temperature of the second layer of ink reaches its transition temperature, which is greater than the transition temperature of the overlying layer, at least a portion of the second layer of ink transitions from a colored to a colorless state, thereby revealing the underlying message “READY!!!” 505. When this occurs, the food item (not shown) is ready to be removed from the microwave oven and consumed.

Although the colors and inks are described herein as being applied in “layers”, it will be understood that this term is used merely for convenience, and that one or more of such colors may be applied in a single coating, such that the color transition occurs within a single physical layer of ink. Additionally, it will be understood that within each layer, both thermochromic and non-thermochromic inks may be used, such that certain components may remain constant throughout all or a portion of the heating process. It also will be understood that one or more inks may have an initial color that is colorless, such that as one ink changes from color to colorless, another ink changes from colorless to a color. It also will be understood that any of such layers may be continuous or discontinuous. Numerous variations of the invention are contemplated hereby.

While various configurations of constructs and inks are provided herein, it will be understood that any configuration may be used as needed or desired. The construct may be flexible, semi-rigid, rigid, or may include a variety of components having different degrees of flexibility. The construct may be in a sheet form, may be a thermally formed construct, may be a sleeve, a carton, or may be configured in any other manner. The construct may be provided in any shape, for example, a square, rectangle, polygon, circle, oval, cylinder, prism, sphere, polyhedron, or ellipsoid. The shape of the construct may be determined largely by the shape of the food product, and it should be understood that different constructs are contemplated for different food products, for example, sandwiches, pizzas, French fries, soft pretzels, pizza bites, cheese sticks, pastries, doughs, and so forth. Likewise, the construct may include gussets, pleats, or any other feature needed or desired to accommodate a particular food item and/or portion size. Additionally, it should be understood that the present invention contemplates constructs for single-serving portions and for multiple-serving portions. It also should be understood that various components used to form the constructs of the present invention may be interchanged. Thus, while only certain combinations are illustrated herein, numerous other combinations and configurations are contemplated hereby.

Numerous materials may be suitable for use in forming the various constructs of the invention, provided that the materials are resistant to softening, scorching, combusting, or degrading at typical microwave oven heating temperatures, for example, at from about 250° F. to about 425° F. The particular materials used may include microwave energy interactive materials and microwave energy transparent or inactive materials.

The various constructs of the present invention may include features that alter the effect of microwave energy during the heating or cooking of the food item. For example, the construct may be formed at least partially from one or more microwave energy interactive elements (hereinafter sometimes referred to as “microwave interactive elements”) that promote browning and/or crisping of a particular area of the food item, shield a particular area of the food item from microwave energy to prevent overcooking thereof, or transmit microwave energy towards or away from a particular area of the food item. Each microwave interactive element comprises one or more microwave energy interactive materials or segments arranged in a particular configuration to absorb microwave energy, transmit microwave energy, reflect microwave energy, or direct microwave energy, as needed or desired for a particular microwave heating construct and food item. In accordance with the invention, one or more thermochromic inks may be located selectively within a construct proximate or distal such elements to regulate and/or control the transition from one color or state to another.

The microwave interactive element may be supported on a microwave inactive or transparent substrate for ease of handling and/or to prevent contact between the microwave interactive material and the food item. As a matter of convenience and not limitation, and although it is understood that a microwave interactive element supported on a microwave transparent substrate includes both microwave interactive and microwave inactive elements or components, such constructs are referred to herein as “microwave interactive webs”.

The microwave energy interactive material may be an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable for use with the present invention include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide. Examples of metal oxides that may be suitable for use with the present invention include, but are not limited to, oxides of aluminum, iron, and tin, used in conjunction with an electrically conductive material where needed. Another example of a metal oxide that may be suitable for use with the present invention is indium tin oxide (ITO). ITO can be used as a microwave energy interactive material to provide a heating effect, a shielding effect, a browning and/or crisping effect, or a combination thereof. For example, to form a susceptor, ITO may be sputtered onto a clear polymeric film. The sputtering process typically occurs at a lower temperature than the evaporative deposition process used for metal deposition. ITO has a more uniform crystal structure and, therefore, is clear at most coating thicknesses. Additionally, ITO can be used for either heating or field management effects. ITO also may have fewer defects than metals, thereby making thick coatings of ITO more suitable for field management than thick coatings of metals, such as aluminum.

Alternatively, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In one example, the microwave interactive element may comprise a thin layer of microwave interactive material that tends to absorb microwave energy, thereby generating heat at the interface with a food item. Such elements often are used to promote browning and/or crisping of the surface of a food item (sometimes referred to as a “browning and/or crisping element”). When supported on a film or other substrate, such an element may be referred to as a “susceptor film” or, simply, “susceptor”.

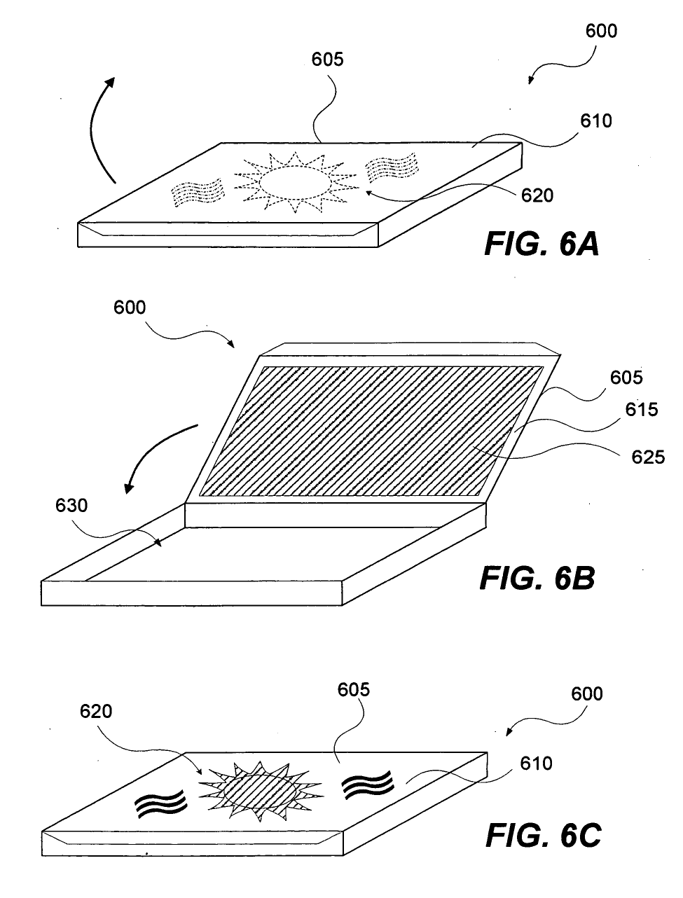

If desired, a thermochromic ink may be applied to the construct proximate a susceptor or susceptor film to accelerate heating of the thermochromic ink and, therefore, the transition from one color or state to another. By way of example, and not limitation, as illustrated in FIGS. 6A-6C, the construct 600 may include at least one panel, in this example, a top panel or lid 605, having opposed first and second sides or surfaces 610 and 615, respectively, where the first side is an outer surface 610 that faces away from the food item (not shown) and the second side is an inner surface 615 that faces toward the food item (not shown). A thermochromic ink 620 may be applied to at least a portion of the outer surface 610 in any suitable pattern (shown with dashed lines in FIG. 6A). In this example, the thermochromic ink either is colorless or is white and therefore, is not visible prior to reaching the transition temperature for the ink (FIG. 6A). A microwave energy interactive element, for example, a susceptor 625, may overlie at least a portion of the inner surface 615 of the panel 605 (FIG. 6B).

As shown in FIGS. 6A-6C, when the construct 600 is exposed to microwave energy (not shown), the susceptor 625 generates thermal energy, some of which is transferred towards the interior 630 of the carton 600, and some which is transferred through the top panel 605 to heat the thermochromic ink 620 on the outer surface 610 thereof. When the thermochromic ink 620 reaches its transition temperature, the ink changes from a colorless state to a colored state and creates a visual impression of an active heating process, in this example, flames and heat waves.

As another example, the microwave interactive element may comprise a foil having a thickness sufficient to shield one or more selected portions of the food item from microwave energy (sometimes referred to as a “shielding element”). Such shielding elements may be used where the food item is prone to scorching or drying out during heating.

The shielding element may be formed from various materials and may have various configurations, depending on the particular application for which the shielding element is used. Typically, the shielding element is formed from a conductive, reflective metal or metal alloy, for example, aluminum, copper, or stainless steel. The shielding element generally may have a thickness of from about 0.000285 inches to about 0.05 inches. In one aspect, the shielding element has a thickness of from about 0.0003 inches to about 0.03 inches. In another aspect, the shielding element has a thickness of from about 0.00035 inches to about 0.020 inches, for example, 0.016 inches.

As still another example, the microwave interactive element may comprise a segmented foil, such as, but not limited to, those described in U.S. Pat. Nos. 6,204,492, 6,433,322, 6,552,315, and 6,677,563, each of which is incorporated by reference in its entirety. Although segmented foils are not continuous, appropriately spaced groupings of such segments often act as a transmitting element to direct microwave energy to specific areas of the food item. Such foils also may be used in combination with browning and/or crisping elements, for example, susceptors. As another example, the microwave interactive element may comprise a foil having a thickness sufficient to shield one or more selected portions of the food item from microwave energy (sometimes referred to as a “shielding element”). Such shielding elements may be used where the food item is prone to scorching or drying out during heating.

The shielding element may be formed from various materials and may have various configurations, depending on the particular application for which the shielding element is used. Typically, the shielding element is formed from a conductive, reflective metal or metal alloy, for example, aluminum, copper, or stainless steel. The shielding element generally may have a thickness of from about 0.000285 inches to about 0.05 inches. In one aspect, the shielding element has a thickness of from about 0.0003 inches to about 0.03 inches. In another aspect, the shielding element has a thickness of from about 0.00035 inches to about 0.020 inches, for example, 0.016 inches.

As still another example, the microwave interactive element may comprise a segmented foil, such as, but not limited to, those described in U.S. Pat. Nos. 6,204,492, 6,433,322, 6,552,315, and 6,677,563, each of which is incorporated by reference in its entirety. Although segmented foils are not continuous, appropriately spaced groupings of such segments often act as a transmitting element to direct microwave energy to specific areas of the food item. Such foils also may be used in combination with browning and/or crisping elements, for example, susceptors.

Any of the numerous microwave interactive elements described herein or contemplated hereby may be substantially continuous, that is, without substantial breaks or interruptions, or may be discontinuous, for example, by including one or more breaks or apertures that transmit microwave energy therethrough. The breaks or apertures may be sized and positioned to heat particular areas of the food item selectively. The number, shape, size, and positioning of such breaks or apertures may vary for a particular application depending on type of construct being formed, the food item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

It will be understood that the aperture may be a physical aperture or void in the material used to form the construct, or may be a non-physical “aperture”. A non-physical aperture may be a portion of the construct that is microwave energy inactive by deactivation or otherwise, or one that is otherwise transparent to microwave energy. Thus, for example, the aperture may be a portion of the construct formed without a microwave energy active material or, alternatively, may be a portion of the construct formed with a microwave energy active material that has been deactivated. While both physical and non-physical apertures allow the food item to be heated directly by the microwave energy, a physical aperture also provides a venting function to allow steam or other vapors to be released from the food item.

As stated above, any of the above elements and numerous others contemplated hereby may be supported on a substrate. The substrate typically comprises an electrical insulator, for example, a polymeric film or material. As used herein the term “polymer” or “polymeric material” includes, but is not limited to, homopolymers, copolymers, such as for example, block, graft, random, and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic, and random symmetries.

The thickness of the film typically may be from about 35 gauge to about 10 mil. In one aspect, the thickness of the film is from about 40 to about 80 gauge. In another aspect, the thickness of the film is from about 45 to about 50 gauge. In still another aspect, the thickness of the film is about 48 gauge. Examples of polymeric films that may be suitable include, but are not limited to, polyolefins, polyesters, polyamides, polyimides, polysulfones, polyether ketones, cellophanes, or any combination thereof. Other non-conducting substrate materials such as paper and paper laminates, metal oxides, silicates, cellulosics, or any combination thereof, also may be used.

In one example, the polymeric film comprises polyethylene terephthalate (PET). Polyethylene terephthalate films are used in commercially available susceptors, for example, the QWIKWAVE® Focus susceptor and the MICRORITE® susceptor, both available from Graphic Packaging International (Marietta, Ga.). Examples of polyethylene terephthalate films that may be suitable for use as the substrate include, but are not limited to, MELINEX®, commercially available from DuPont Teijan Films (Hopewell, Va.), SKYROL, commercially available from SKC, Inc. (Covington, Ga.), and BARRIALOX PET, available from Toray Films (Front Royal, Va.), and QU50 High Barrier Coated PET, available from Toray Films (Front Royal, Va.).

The polymeric film may be selected to impart various properties to the microwave interactive web, for example, printability, heat resistance, or any other property. As one particular example, the polymeric film may be selected to provide a water barrier, oxygen barrier, or a combination thereof. Such barrier film layers may be formed from a polymer film having barrier properties or from any other barrier layer or coating as desired. Suitable polymer films may include, but are not limited to, ethylene vinyl alcohol, barrier nylon, polyvinylidene chloride, barrier fluoropolymer, nylon 6, nylon 6,6, coextruded nylon 6/EVOH/nylon 6, silicon oxide coated film, barrier polyethylene terephthalate, or any combination thereof.

One example of a barrier film that may be suitable for use with the present invention is CAPRAN® EMBLEM 1200M nylon 6, commercially available from Honeywell International (Pottsville, Pa.). Another example of a barrier film that may be suitable is CAPRAN® OXYSHIELD OBS monoaxially oriented coextruded nylon 6/ethylene vinyl alcohol (EVOH)/nylon 6, also commercially available from Honeywell International. Yet another example of a barrier film that may be suitable for use with the present invention is DARTEK® N-201 nylon 6,6, commercially available from Enhance Packaging Technologies (Webster, N.Y.). Additional examples include BARRIALOX PET, available from Toray Films (Front Royal, Va.) and QU50 High Barrier Coated PET, available from Toray Films (Front Royal, Va.), referred to above.

Still other barrier films include silicon oxide coated films, such as those available from Sheldahl Films (Northfield, Minn.). Thus, in one example, a susceptor may have a structure including a film, for example, polyethylene terephthalate, with a layer of silicon oxide coated onto the film, and ITO or other material deposited over the silicon oxide. If needed or desired, additional layers or coatings may be provided to shield the individual layers from damage during processing.

The barrier film may have an oxygen transmission rate (OTR) as measured using ASTM D3985 of less than about 20 cc/m²/day. In one aspect, the barrier film has an OTR of less than about 10 cc/m²/day. In another aspect, the barrier film has an OTR of less than about 1 cc/m²/day. In still another aspect, the barrier film has an OTR of less than about 0.5 cc/m²/day. In yet another aspect, the barrier film has an OTR of less than about 0.1 cc/m²/day.

The barrier film may have a water vapor transmission rate (WVTR) of less than about 100 g/m²/day as measured using ASTM F1249. In one aspect, the barrier film has a water vapor transmission rate (WVTR) as measured using ASTM F1249 of less than about 50 g/m²/day. In another aspect, the barrier film has a WVTR of less than about 15 g/m²/day. In yet another aspect, the barrier film has a WVTR of less than about 1 g/m²/day. In still another aspect, the barrier film has a WVTR of less than about 0.1 g/m²/day. In a still further aspect, the barrier film has a WVTR of less than about 0.05 g/m²/day.

Other non-conducting substrate materials such as metal oxides, silicates, cellulosics, or any combination thereof, also may be used in accordance with the present invention.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item.

For example, the microwave energy interactive material may be provided as a continuous or discontinuous layer or coating including circles, loops, hexagons, islands, squares, rectangles, octagons, and so forth. Examples of various patterns and methods that may be suitable for use with the present invention are provided in U.S. Pat. Nos. 6,765,182; 6,717,121; 6,677,563; 6,552,315; 6,455,827; 6,433,322; 6,414,290; 6,251,451; 6,204,492; 6,150,646; 6,114,679; 5,800,724; 5,759,422; 5,672,407; 5,628,921; 5,519,195; 5,424,517; 5,410,135; 5,354,973; 5,340,436; 5,266,386; 5,260,537; 5221,419; 5,213,902; 5,117,078; 5,039,364; 4,963,424; 4,936,935; 4,890,439; 4,775,771; 4,865,921; and Re. 34,683, each of which is incorporated by reference herein in its entirety. Although particular examples of patterns of microwave energy interactive material are shown and described herein, it should be understood that other patterns of microwave energy interactive material are contemplated by the present invention.

The microwave interactive element or microwave interactive web may be joined to or overlie a dimensionally stable, microwave energy transparent support (hereinafter referred to as “microwave transparent support”, “microwave inactive support” or “support”) to form the construct.

In one aspect, for example, where a rigid or semi-rigid construct is to be formed, all or a portion of the support may be formed at least partially from a paperboard material, which may be cut into a blank prior to use in the construct. For example, the support may be formed from paperboard having a basis weight of from about 60 to about 330 lbs/ream, for example, from about 80 to about 140 lbs/ream. The paperboard generally may have a thickness of from about 6 to about 30 mils, for example, from about 12 to about 28 mils. In one particular example, the paperboard has a thickness of about 12 mils. Any suitable paperboard may be used, for example, a solid bleached or solid unbleached sulfate board, such as SUS® board, commercially available from Graphic Packaging International.

Alternatively, where a flexible construct is to be formed, for example, the support may comprise a polymer or polymeric material, such as those described above. Examples of polymers that may be suitable for use with the present invention include, but are not limited to, polycarbonate; polyolefins, e.g. polyethylene, polypropylene, polybutylene, and copolymers thereof; polytetrafluoroethylene; polyesters, e.g. polyethylene terephthalate, e.g., coextruded polyethylene terephthalate; vinyl polymers, e.g., polyvinyl chloride, polyvinyl alcohol, ethylene vinyl alcohol, polyvinylidene chloride, polyvinyl acetate, polyvinyl chloride acetate, polyvinyl butyral; acrylic resins, e.g. polyacrylate, polymethylacrylate, and polymethylmethacrylate; polyamides, e.g., nylon 6,6; polystyrenes; polyurethanes; cellulosic resins, e.g., cellulosic nitrate, cellulosic acetate, cellulosic acetate butyrate, ethyl cellulose; copolymers of any of the above materials; or any blend or combination thereof. Other materials are contemplated hereby.

In another aspect, the support may comprise a paper or paper-based material generally having a basis weight of from about 15 to about 60 lbs/ream, for example, from about 20 to about 40 lbs/ream. In one particular example, the paper has a basis weight of about 25 lbs/ream.

Optionally, one or more portions of the various blanks or other constructs described herein or contemplated hereby may be coated with varnish, clay, or other materials, either alone or in combination. The coating may then be printed over with product advertising or other information or images. The blanks or other constructs also may be coated to protect any information printed thereon.

Furthermore, the blanks or other constructs may be coated with, for example, a moisture and/or oxygen barrier layer, on either or both sides, such as those described above. Any suitable moisture and/or oxygen barrier material may be used in accordance with the present invention. Examples of materials that may be suitable include, but are not limited to, polyvinylidene chloride, ethylene vinyl alcohol, DuPont DARTEK™ nylon 6,6, and others referred to above.

Alternatively or additionally, any of the blanks or other constructs of the present invention may be coated or laminated with other materials to impart other properties, such as absorbency, repellency, opacity, color, printability, stiffness, or cushioning. For example, absorbent susceptors are described in U.S. Provisional Application No. 60/604,637, filed Aug. 25, 2004, and U.S. patent application Ser. No. 11/211,858, to Middleton, et al., titled “Absorbent Microwave Interactive Packaging”, filed Aug. 25, 2005, both of which are incorporated herein by reference in their entirety. Additionally, the blanks or other constructs may include graphics or indicia printed thereon.

It will be understood that with some combinations of elements and materials, the microwave interactive element may have a grey or silver color this is visually distinguishable from the substrate or the support. However, in some instances, it may be desirable to provide a web or construct having a uniform color and/or appearance. Such a web or construct may be more aesthetically pleasing to a consumer, particularly when the consumer is accustomed to packages or containers having certain visual attributes, for example, a solid color, a particular pattern, and so on. Thus, for example, the present invention contemplates using a silver or grey toned adhesive to join the microwave interactive elements to the substrate, using a silver or grey toned substrate to mask the presence of the silver or grey toned microwave interactive element, using a dark toned substrate, for example, a black toned substrate, to conceal the presence of the silver or grey toned microwave interactive element, overprinting the metallized side of the web with a silver or grey toned ink to obscure the color variation, printing the non-metallized side of the web with a silver or grey ink or other concealing color in a suitable pattern or as a solid color layer to mask or conceal the presence of the microwave interactive element, or any other suitable technique or combination thereof.

If desired, a combination of paper layers, polymer film layers, and microwave interactive elements may be used to form a microwave energy interactive insulating material. As used herein, the term “microwave energy interactive insulating material” or “microwave interactive insulating material” or “insulating material” refers any combination of layers of materials that is both responsive to microwave energy and capable of providing some degree of thermal insulation when used to heat a food item. An insulating material may be used to form all or a portion of a construct used in accordance with the present invention. For example, an insulating material may be used to form all or a portion of a wrapper, sleeve, pouch, or other package according to the invention.

The insulating material may include various components, provided that each is resistant to softening, scorching, combusting, or degrading at typical microwave oven heating temperatures, for example, at from about 250° F. to about 425° F. The insulating material may include both microwave energy responsive or interactive components, and microwave energy transparent or inactive components.

In one aspect, the insulating material comprises one or more susceptor layers in combination with one or more expandable insulating cells. Additionally, the insulating material may include one or more microwave energy transparent or inactive materials to provide dimensional stability, to improve ease of handling the microwave energy interactive material, and/or to prevent contact between the microwave energy interactive material and the food item. For example, an insulating material may comprise a microwave energy interactive material supported on a first polymeric film layer, a moisture-containing layer superposed with the microwave energy interactive material, and a second polymeric film layer joined to the moisture-containing layer in a predetermined pattern, thereby forming one or more closed cells between the moisture-containing layer and the second polymeric film layer. The closed cells expand or inflate in response to being exposed to microwave energy, and thereby causing microwave energy interactive material to bulge and deform.

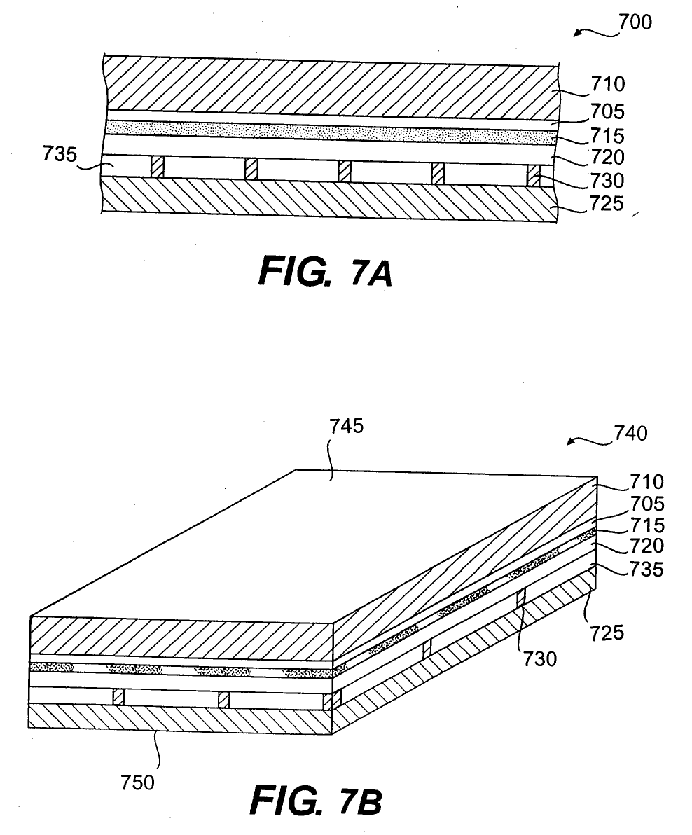

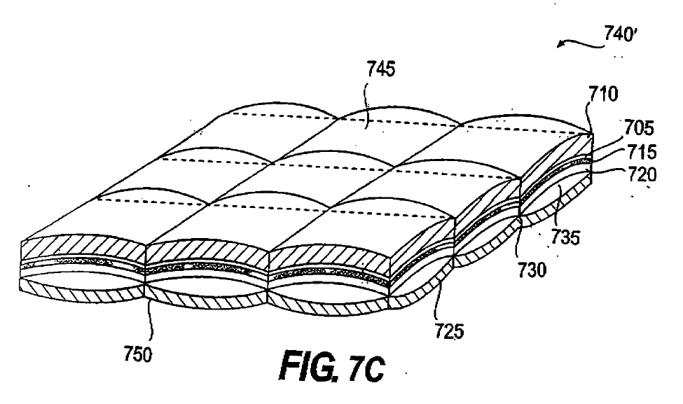

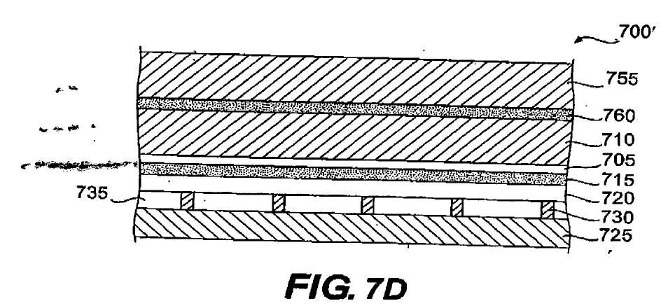

Several exemplary insulating materials are depicted in FIGS. 7A-10C. For purposes of simplicity, like numerals may be used to describe like features. It will be understood that where a plurality of similar features are depicted, not all of such features are necessarily labeled on each figure. While various exemplary embodiments are shown and described in detail herein, it also will be understood that any of the features may be used in any combination, and that such combinations are contemplated hereby. Further, in each of the examples shown herein, it should be understood that the layer widths are not necessarily shown in perspective. In some instances, for example, the adhesive layers may be very thin with respect to other layers, but are nonetheless shown with some thickness for purposes of clearly illustrating the arrangement of layers.

FIG. 7A depicts an exemplary insulating material 700 that may be used with various aspects of the invention. In this example, a thin layer of microwave energy interactive material 705 is supported on a first polymeric film 710 and bonded by lamination with an adhesive 715 (or otherwise) to a dimensionally stable substrate 720, for example, paper. The substrate 720 is bonded to a second plastic film 725 using a patterned adhesive 730 or other material, such that closed cells 735 are formed in the material 700. The insulating material 700 may be cut and provided as a substantially flat, multi-layered sheet 740, as shown in FIG. 7B.

As the microwave energy interactive material 705 heats upon impingement by microwave energy, water vapor and other gases typically held in the substrate 720, for example, paper, and any air trapped in the thin space between the second plastic film 725 and the substrate 720 in the closed cells 735, expand, as shown in FIG. 7C. The resulting insulating material 740′ has a quilted or pillowed top surface 745 and bottom surface 750. When microwave heating has ceased, the cells 735 typically deflate and return to a somewhat flattened state. In some instances, however, the insulating material may remain at least partially expanded, as will be discussed below.

Optionally, the insulating material 700′ may include an additional microwave transparent layer 755 adhered by adhesive 760 or otherwise to the polymeric film 710 opposite the microwave energy interactive material 705, as depicted in FIG. 7D. The additional microwave transparent layer 755 may be a layer of paper, film, or any other suitable material, and may be provided to shield the food item (not shown) from any flakes of susceptor film that craze and peel away from the insulating material 700′ during heating.

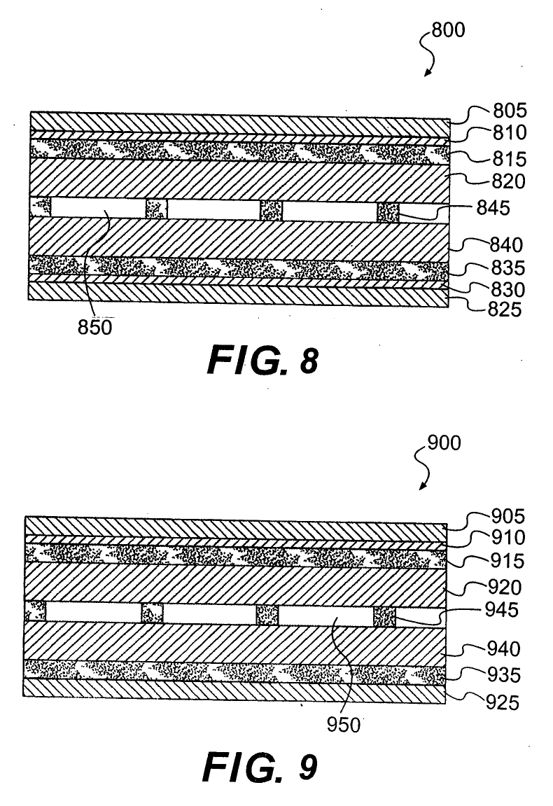

FIGS. 8 and 9 depict other exemplary insulating materials according to various aspects of the present invention. Referring first to FIG. 8, an insulating material 800 is shown with two symmetrical layer arrangements adhered together by a patterned adhesive layer. The first symmetrical layer arrangement, beginning at the top of the drawings, comprises a PET film layer 805, a metal layer 810, an adhesive layer 815, and a paper or paperboard layer 880. The metal layer 810 may comprise a metal, such as aluminum, deposited along at least a portion of the PET film layer 805. The PET film 805 and metal layer 810 together define a susceptor. The adhesive layer 815 bonds the PET film 805 and the metal layer 810 to the paperboard layer 820.

The second symmetrical layer arrangement, beginning at the bottom of the drawings, also comprises a PET film layer 825, a metal layer 830, an adhesive layer 835, and a paper or paperboard layer 840. If desired, the two symmetrical arrangements may be formed by folding one layer arrangement onto itself. The layers of the second symmetrical layer arrangement are bonded together in a similar manner as the layers of the first symmetrical arrangement. A patterned adhesive layer 845 is provided between the two paper layers 820 and 840, and defines a pattern of closed cells 850 configured to expand when exposed to microwave energy. By using an insulating material 800 having two metal layers 810 and 830, more heat is generated, thereby achieving greater cell loft. As a result, such a material is able to elevate a food item seated thereon to a greater extent than an insulating material having a single microwave energy interactive material layer.

Referring to FIG. 9, yet another insulating material 900 is shown. The material 900 includes a PET film layer 905, a metal layer 910, an adhesive layer 915, and a paper layer 920. Additionally, the material 900 may include a clear PET film layer 925, an adhesive 935, and a paper layer 940. The layers are adhered or affixed by a patterned adhesive 945 defining a plurality of closed expandable cells 950.

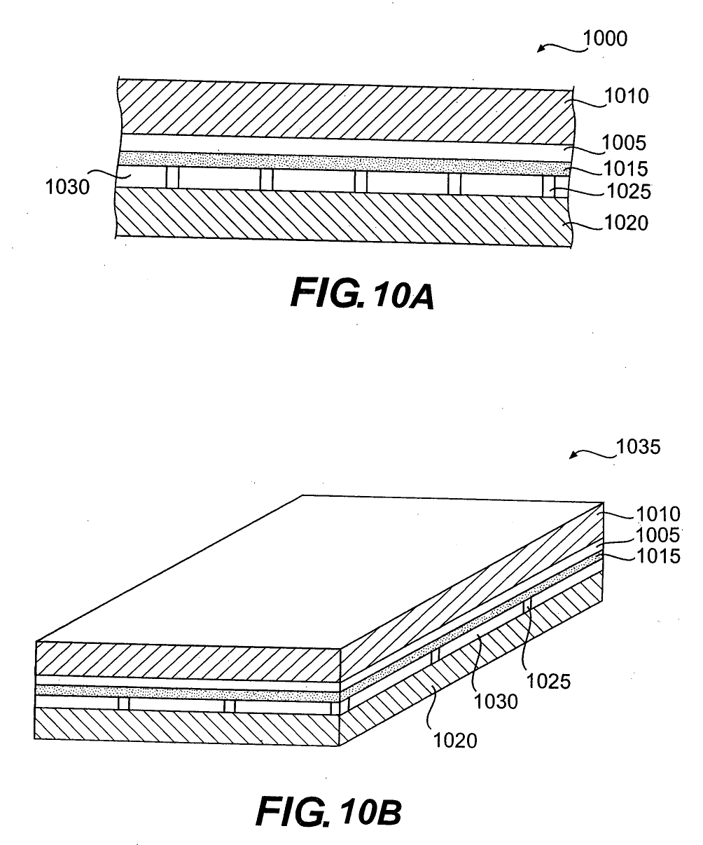

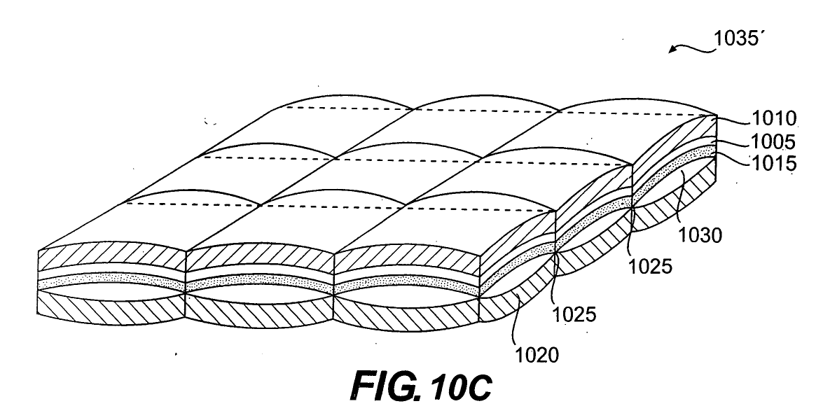

Turning now to FIGS. 10A-10C, another exemplary insulating material 1000 is depicted. In this example, one or more reagents are used to generate a gas that expands the cells of the insulating material. In this example, one or more reagents are used to generate a gas that expands the cells of the insulating material. For example, the reagents may comprise sodium bicarbonate (NaHCO₃) and a suitable acid. When exposed to heat, the reagents react to produce carbon dioxide. As another example, the reagent may comprise a blowing agent. Examples of blowing agents that may be suitable include, but are not limited to, p-p′-oxybis(benzenesulphonylhydrazide), azodicarbonamide, and p-toluenesulfonylsemicarbazide. However, it will be understood that numerous other reagents and released gases are contemplated hereby.

In the example shown in FIG. 10A, a thin layer of microwave interactive material 1005 is supported on a first plastic film 1010 to form a susceptor film. One or more reagents 1015, optionally within a coating, overlie at least a portion of the layer of microwave interactive material 1005. The reagent 1015 is joined to a second plastic film 1020 using a patterned adhesive 1025 or other material, or using thermal bonding, ultrasonic bonding, or any other suitable technique, such that closed cells 1030 (shown as a void) are formed in the material 1000. The insulating material 1000 may be cut into a sheet 1035, as shown in FIG. 10B.

FIG. 10C depicts the exemplary insulating material 1035 of FIG. 10B after being exposed to microwave energy from a microwave oven (not shown). As the microwave interactive material 1005 heats upon impingement by microwave energy, water vapor or other gases are released from or generated by the reagent 1015. The resulting gas applies pressure on the susceptor film 1010 on one side and the second plastic film 1020 on the other side of the closed cells 1030. Each side of the material 1000 forming the closed cells 1030 reacts simultaneously, but uniquely, to the heating and vapor expansion to form a quilted insulating material 1035′. This expansion may occur within 1 to 15 seconds in an energized microwave oven, and in some instances, may occur within 2 to 10 seconds. Even without a paper or paperboard layer, the water vapor resulting from the reagent is sufficient both to inflate the expandable cells and to absorb any excess heat from the microwave energy interactive material.

Typically, when microwave heating has ceased, the cells or quilts may deflate and return to a somewhat flattened state. Alternatively, the insulating material may comprise a durably expandable microwave energy interactive insulating material. As used herein, the term “durably expandable microwave energy interactive insulating material” or “durably expandable insulating material” refers to an insulating material that includes expandable cells that tend to remain at least partially, substantially, or completely inflated after exposure to microwave energy has been terminated. Such materials may be used to form multi-functional packages and other constructs that can be used to heat a food item, to provide a surface for safe and comfortable handling of the food item, and to contain the food item after heating. Thus, a durably expandable insulating material may be used to form a package or construct that facilitates storage, preparation, transportation, and consumption of a food item, even “on the go”.

In one aspect, a substantial portion of the plurality of cells remain substantially expanded for at least about 1 minute after exposure to microwave energy has ceased. In another aspect, a substantial portion of the plurality of cells remain substantially expanded for at least about 5 minutes after exposure to microwave energy has ceased. In still another aspect, a substantial portion of the plurality of cells remain substantially expanded for at least about 10 minutes after exposure to microwave energy has ceased. In yet another aspect, a substantial portion of the plurality of cells remain substantially expanded for at least about 30 minutes after exposure to microwave energy has ceased. It will be understood that not all of the expandable cells in a particular construct or package must remain inflated for the insulating material to be considered to be “durable”. Instead, only a sufficient number of cells must remain inflated to achieve the desired objective of the package or construct in which the material is used.

For example, where a durably expandable insulating material is used to form all or a portion of a package or construct for storing a food item, heating, browning, and/or crisping the food item in a microwave oven, removing it from the microwave oven, and removing it from the construct, only a sufficient number of cells need to remain at least partially inflated for the time required to heat, brown, and/or crisp the food item and remove it from the microwave oven after heating. In contrast, where a durably expandable insulating material is used to form all or a portion of a package or construct for storing a food item, heating, browning, and/or crisping the food item in a microwave oven, removing the food item from the microwave oven, and consuming the food item within the construct, a sufficient number of cells need to remain at least partially inflated for the time required to heat, brown, and/or crisp the food item, remove it from the microwave oven after heating, and transport the food item until the food item and/or construct has cooled to a surface temperature comfortable for contact with the hands of the user.

Any of the durably expandable insulating materials of the present invention may be formed at least partially from one or more barrier materials, for example, polymeric films, that substantially reduce or prevent the transmission of oxygen, water vapor, or other gases from the expanded cells. Examples of such materials are described above. However, the use of other materials is contemplated hereby.

It will be understood that the various insulating materials of the present invention enhance heating, browning, and crisping of a food item in a microwave oven. First, the water vapor, air, and other gases contained in the closed cells provide insulation between the food item and the ambient environment of the microwave oven, thereby increasing the amount of sensible heat that stays within or is transferred to the food item. Additionally, the formation of the cells allows the material to conform more closely to the surface of the food item, placing the susceptor film in greater proximity to the food item, thereby enhancing browning and/or crisping. Furthermore, insulating materials may help to retain moisture in the food item when cooking in the microwave oven, thereby improving the texture and flavor of the food item. Additional benefits and aspects of such materials are described in PCT Application No. PCT/US03/03779, U.S. application Ser. No. 10/501,003, and U.S. application Ser. No. 11/314,851, each of which is incorporated by reference herein in its entirety.

Any of the insulating materials described herein or contemplated hereby may include an adhesive pattern or thermal bond pattern that is selected to enhance cooking of a particular food item. For example, where the food item is a larger item, the adhesive pattern may be selected to form substantially uniformly shaped expandable cells. Where the food item is a small item, the adhesive pattern may be selected to form a plurality of different sized cells to allow the individual items to be variably contacted on their various surfaces. While several examples are provided herein, it will be understood that numerous other patterns are contemplated hereby, and the pattern selected will depend on the heating, browning, crisping, and insulating needs of the particular food item.

If desired, multiple layers of insulating materials may be used to enhance the insulating properties of the insulating material and, therefore, enhance the browning and crisping of the food item. Where multiple layers are used, the layers may remain separate or may be joined using any suitable process or technique, for example, thermal bonding, adhesive bonding, ultrasonic bonding or welding, mechanical fastening, or any combination thereof. In one example, two sheets of an insulating material may be arranged so that their respective susceptor film layers are facing away from each other. In another example, two sheets of an insulating material may be arranged so that their respective susceptor film layers are facing towards each other. In still another example, multiple sheets of an insulating material may be arranged in a like manner and superposed. In a still further example, multiple sheets of various insulating materials are superposed in any other configuration as needed or desired for a particular application.

Although certain embodiments of this invention have been described with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention and to provide the best mode contemplated by the inventor or inventors of carrying out the invention. The detailed description set forth herein is not intended nor is to be construed to limit the present invention or otherwise to exclude any such other embodiments, adaptations, variations, modifications, and equivalent arrangements of the present invention.

What is claimed is:

1. A construct for heating a food item in a microwave oven, the construct comprising:
a presentment formed at least partially from a thermochromic ink that undergoes a change in color as a function of temperature, wherein the presentment creates an impression of an active heating process.

2. The construct of claim 1, wherein the presentment comprises an electrical coil, a flame, a grill pattern, heat waves, smoke, a natural gas burner, or any combination thereof.

3. The construct of claim 1, wherein
the change in color comprises a transition from a colorless state to a colored state, and
the presentment is visible in the colored state.

4. The construct of claim 1, wherein the thermochromic ink is positioned proximate a microwave energy interactive material.

5. The construct of claim 1, wherein the construct comprises at least one panel having a first surface and a second surface, wherein a susceptor overlies at least a portion of the first surface and the thermochromic ink overlies at least a portion of the second surface.

6. A construct for heating a food item in a microwave oven, the construct comprising:
an indicium formed at least partially from a thermochromic ink that undergoes a change in color at a transition temperature, wherein the change in color of the thermochromic ink indicates the status of the heating of the food item.

7. The construct of claim 6, wherein the change in color of the thermochromic ink comprises a transition from a colorless state to a colored state.

8. The construct of claim 6, wherein the change in color of the thermochromic ink comprises a transition from a colored state to a colorless state.

9. The construct of claim 6, wherein the change in color of the thermochromic ink comprises a transition from a first color to a second color.

10. The construct of claim 6, wherein the transition temperature of the thermochromic ink is selected to correspond to a temperature of the food item at a particular point in the heating process.

11. The construct of claim 6, wherein the indicium comprises a word, number, symbol, shape, pattern, or any combination thereof.

12. The construct of claim 6, wherein the indicium is disposed on an outer surface of the construct.

13. A construct for heating a food item in a microwave oven, comprising:
a presentment formed from an ink applied to at least a portion of an outer surface of the construct; and
a thermochromic ink overlying the presentment, wherein
the thermochromic ink transitions from a colored state to a colorless state at a color transition temperature,
the color transition temperature corresponds to the temperature of the food item at a particular point in the heating process,
the transition from the colored state to the colorless state reveals the presentment, and
the revealing of the presentment serves as an indicator that the food item has reached the particular point in the heating process.

14. The construct of claim 13, wherein the presentment is a word, number, symbol, shape, pattern, or any combination thereof.

15. The construct of claim 13, wherein the thermochromic ink substantially conceals the presentment.

16. The construct of claim 13, wherein the presentment comprises a non-thermochromic ink.

17. The construct of claim 13, wherein the presentment comprises a thermochromic ink.

18. The construct of claim 17, wherein the thermochromic ink of the presentment transitions from a colored state to a colorless state at a color transition temperature approximately equal to the color transition temperature of the overlying thermochromic ink.

19. The construct of claim 17, wherein the thermochromic ink of the presentment transitions from a colored state to a colorless state at a color transition temperature different from the color transition temperature of the overlying thermochromic ink.

20. The construct of claim 17, wherein the thermochromic ink of the presentment transitions from a colorless state to a colored state at a color transition temperature approximately equal to the color transition temperature of the overlying thermochromic ink.

21. The construct of claim 17, wherein the thermochromic ink of the presentment transitions from a colorless state to a colored state at a color transition temperature different from the color transition temperature of the overlying thermochromic ink.

22. A construct for heating a food item in a microwave oven, the construct comprising a thermochromic ink overlying at least a portion of an outer surface thereof, wherein:
the thermochromic ink changes from a first color to a second color in response to thermal energy,
the thermochromic ink is selected such that the change from the first color to the second color occurs at a predetermined point in the heating process of the food item, and
the change in color of the thermochromic ink is used to create an impression of active heating, provide a status of the heating of the food item, provide instructions for processing or handling the food item, or any combination thereof.

23. The construct of claim 22, wherein at least one of the first color and the second color is colorless.

24. The construct of claim 22, wherein both the first color and the second color are not colorless.

25. The construct of claim 22, further comprising a non-thermochromic ink overlying at least a portion of the outer surface.

26. The construct of claim 22, wherein
the change in color of the thermochromic ink is used to create an impression of active heating, and
the impression of active heating comprises a presentment selected from the group consisting of an electrical coil, a flame, a grill pattern, heat waves, smoke, a natural gas burner, and any combination thereof.

27. The construct of claim 22, wherein
the change in color of the thermochromic ink is used to provide instructions for processing or handling the food item, and
the instructions advise the user to wait, stir the food item, invert the food item, remove the cover, remove the plastic film, remove the food item, add ingredients, or any combination thereof.

28. The construct of claim 22, wherein the change in color of the thermochromic ink is reversible.

29. The construct of claim 22, wherein the change in color of the thermochromic ink is irreversible.

30. A construct for heating a food item in a microwave oven, the construct comprising a thermochromic ink that undergoes a change in color as a function of temperature to reveal a presentment, wherein the presentment:
provides instructions about the use of the construct;
provides information about a theme presented with the construct;
provides educational information;
provides entertainment to a user; or
any combination thereof.

31. The construct of claim 30, wherein the change in color of the thermochromic ink comprises a transition from a colorless state to a colored state.

32. The construct of claim 30, wherein the change in color of the thermochromic ink comprises a transition from a colored state to a colorless state.

33. The construct of claim 30, wherein the change in color of the thermochromic ink comprises a transition from a first color to a second color.

34. The construct of claim 30, wherein the thermochromic ink substantially conceals the presentment.

35. The construct of claim 30, wherein the presentment comprises a non-thermochromic ink.

36. The construct of claim 30, wherein the presentment comprises a thermochromic ink.
